(19) United States
(12) Patent Application Publication
(10) Pub. No.: US 2012/0035319 A1
(43) Pub. Date: Feb. 9, 2012

(54) BORATE AND POLYMER COMPOSITIONS FOR THE REPAIR AND MAINTENANCE OF RAILROAD TIES

(76) Inventors: Doug Delmonico, Broomfield, CO (US); Fabian Weber, Boulder, CO (US)

(21) Appl. No.: 13/197,473

(22) Filed: Aug. 3, 2011

Related U.S. Application Data
(63) Continuation-in-part of application No. 12/931,595, filed on Feb. 3, 2011.
(60) Provisional application No. 61/301,091, filed on Feb. 3, 2010.

(51) Int. Cl. C09K 21/14; B05D 1/02; C09K 21/02

(52) U.S. Cl. 524/701; 427/427.4

(57) ABSTRACT

A remedial railroad tie repair treatment capable of extending the useful life of a railroad tie. The remedial repair treatment comprises a mixture of a borate solution and a chemical tie plugging compound combined that, when applied to a wooden area of interest, will delay the decay thereof and facilitate penetration of the borate through the wood fibers. The remedial repair treatment may alternatively comprise sequential application of the borate solution and the plugging compound to the wooden area of interest.

This application is a continuation-in-part of U.S. patent application Ser. No. 12/931,595 filed on Feb. 3, 2011, and entitled “BORATE AND POLYMER COMPOSITIONS FOR THE REPAIR AND MAINTENANCE OF RAILROAD TIES,” which claims the benefit of U.S. Provisional Application No. 61/301,091, filed Feb. 3, 2010, all of which are incorporated by reference herein in their entirety.

### BACKGROUND OF THE INVENTION

Wood is the predominate material used for railroad ties, due in large part to its widespread availability, low cost, industry familiarity, and the conventional mastery of its physical and engineering characteristics. Railroad ties conventionally comprise a decay-susceptible heartwood core surrounded by a band or shell of sapwood that has been pressure treated with preservative compositions. The preservative compositions used to treat the railroad ties generally comprise creosote, either alone or in combination with other preservatives including borates (i.e. boric acid and its salts) and copper naphthenate. These compounds are typically used to treat the sapwood layer of the wooden railroad ties in addition to creosote in order to prevent attack by fungi and insects, as there is limited penetration of creosote into ties. However, certain preservative treatments—boric acid and its water-soluble salts, in particular—are extremely mobile in wood in the presence of water. Continued exposure to weather can leach the preservative treatments from the tie very rapidly, thereby making the tie more susceptible to attacks from insects or fungi. While subsequent treatment of the tie with creosote or another sealer may prevent such leaching, such treatments can be compromised through normal wear and tear.

Provided the treated shell of a railroad tie remains intact and a sufficient amount of preservatives remain within the wood, the useful life of railroad ties can be over 30 years. However, the leaching of preservative treatments is not the only manner through which treated ties may be weakened. The development of checking or cracking in the tie may permit penetration of the creosote layer and allow entry of either fungi or insects into the untreated heartwood, which could lead to early failure. Similarly, processes such as driving spikes or drilling holes for spikes or other hardware that occur after the preservative treatment is applied may also promote early failure as such processes provide an entry point for moisture and fungi into the wood. While it is conventionally known to repair spike holes by filling the void with a plugging compound, such chemical compounds do little to repair and/or kill any existing fungi within the tie or prevent the spread of the same.

Similarly, part of the general maintenance of a railroad system involves adzing the top of each wood tie at or near the location of the plate, the rail seat area, to ensure the surface of the tie is even and the tie plates lie flat thereon. When this adzing process is performed, about an 18 inch surfacing cut across the tie exposes the fibers of the untreated wood of the tie. This area of the tie, the rail seat, is the most probable area of the tie to be damaged by tie plates cutting into the tie and therefore a likely entry point for fungi. Any adzing and/or cutting that occurs during the periodic maintenance of a tie necessarily removes the preservative treatment that was originally applied and thus leaves untreated wood exposed and vulnerable to fungi and insect damage.

### SUMMARY OF THE INVENTION

Compositions are provided for the remedial treatment of a railroad tie and, specifically, to prevent the decay thereof. In at least one embodiment, the composition comprises a plugging compound and a borate. The plugging compound may be adapted to undergo a reaction that produces heat, such as a quick-curing compound that undergoes an exothermic reaction. The borate may comprise any borates known in the art and, in at least one embodiment, the borate may comprise a borate solution.

Methods for using the above-described composition to remedially treat a decaying railroad tie are also disclosed herein. In at least one embodiment, a method for remedially treating decay of a railroad tie comprises the steps of applying a borate solution to a railroad tie, the borate solution adapted to diffuse through at least a portion of the railroad tie; applying a plugging compound to the railroad tie, the plugging compound adapted to undergo a reaction that produces heat; facilitating the reaction of the plugging compound; and employing the heat of the reaction to facilitate penetration of the borate solution into at least a portion of the railroad tie.

Additionally, at least one embodiment is described of a method for remedially treating decay of a railroad tie comprising the steps of applying a composition to a railroad tie, the composition comprising a borate solution and a plugging compound, the borate solution adapted to facilitate penetration of the borate through at least a portion of the railroad tie and the plugging compound adapted to undergo a reaction that produces heat; facilitating the reaction of the plugging compound; and employing the heat of the reaction to facilitate penetration of the borate solution into at least a portion of the railroad tie. Alternatively, in at least one embodiment a composition comprising a borate solution and a sealing compound may be employed in connection with the steps of the method, where the sealing compound is adapted to form a barrier at or near an exterior surface of the railroad tie.

In yet another embodiment, the composition is a polymer system for treatment of railroad ties to improve resistance to fire. The polymer system comprises an isocyanate, an active hydrogen containing compound, and a borate compound in an amount of about 25% to about 60% by weight of the active hydrogen containing compound.

### BRIEF DESCRIPTION OF THE DRAWINGS

FIG. 1 shows a line drawing representation of a photograph of a cross-section of a simulated spike hole that has been treated with a spray composition as set forth in Example 1;

FIG. 2 shows a line drawing representation of a photograph of a cross-section of a simulated spike hole that has been treated with a foam composition as set forth in Example 2;

FIG. 3 shows a line drawing representation of a photograph of a cross-section of a simulated spike hole that has been treated with both spray and foam compositions as set forth in Example 3;

FIG. 4a shows a line drawing representation of a photograph of cross-sections of spike holes in oak ties that have been treated with a liquid composition and thereafter a foam composition (as set forth in Example 4), prior to the application of a borate indicator; and

FIG. 4b shows a line drawing representation of a photograph of cross-sections of the spike holes of FIG. 4a after the application of a borate indicator and the borate penetration therein.

### DETAILED DESCRIPTION OF THE INVENTION

Reference will now be made to various embodiments and specific language will be used to describe the same. It will nevertheless be understood that no limitation of scope is intended by the description of these embodiments.

Supplementary or remedial treatments can be used to materially increase the useful life of ties. Specifically, the in situ application of a repair composition described herein to a railroad tie has shown to significantly extend the useful life of a railroad tie. Unlike the preservative treatments applied to railroad ties during the manufacturing process, remedial application of the repair composition to a railroad tie is a second line of defense that may be employed in the field on an as-needed basis. Specifically, the repair composition described herein is capable of delaying the overall decay of the wood, killing any existing fungi that may be present within the wood ties, and penetrating the wood fibers to prevent the spread of such fungi and the associated decay in the event external factors have reduced or obviated the effects of any preservative treatments that were initially applied during the tie manufacturing process.

The repair composition comprises a plugging compound for repairing the physical damage to the tie and a borate. The plugging compound and borate are each present in the repair composition in sufficient amounts such that when the repair composition is applied to a void left in a wood railroad tie from a spike or otherwise, the repair composition is capable of delaying the decay of the wood railroad tie, killing any existing fungi present therein, and preventing the spread of decay caused by said fungi throughout the wood.

The repair composition may be a curable polymer system or composition, as are known in the art. In at least one embodiment, the polymer system is cured by an exothermic reaction. In addition to the preservative properties of the individual components of the repair composition, application of the repair composition to a tie exploits the exothermic curing reaction of the plugging compound to not only kill any fungi surrounding the void, but also facilitate the penetration of the borate through the wood. Accordingly, remedial application of the repair composition to a compromised railroad tie repairs decay by filling the cavities and other damaged areas of the tie with a plugging compound that simulates the material of the tie, and by applying borate, a known biocide, directly to the contaminated areas of the tie, and prevents any future development of the same, assuming the compromised area of the tie was in the vicinity of the hole being repaired. In this manner, the useful life of the laid tie is extended, which ultimately reduces the overall costs associated with replacing failed railroad ties.

The plugging compound of the repair composition comprises any chemical tie plugging repair material known in the art, including polymer compositions such as a chemical polyurethane compound, a polyurea compound, a chemical urethane compound, an epoxy compound, a polyol compound, a quick-curing polymer, or a combination of any of the aforementioned. In at least one embodiment, the plugging compound comprises a high-density polyurethane. In an alternative embodiment, the repair composition comprises a 2-component plugging compound having about a 1:1 or 1:2 ratio by volume of isocyanate and polyol, where borate is incorporated into at least one of the components. The plugging compound is preferably formulated to develop a density similar to that of the wood or other material to which it is to be applied. For example, and without any intended limitation, the plugging compound may form about a 38 to 45 pound per cubic foot density. In this manner, when the plugging compound is used to fill a spike hole or a portion thereof, the plugging compound can retain a spike as efficiently as did the original wood.

The borate of the repair composition may comprise any borate that is suitable for the chemical preservation of wood, including, without limitation, the commercially available borate products Am Bor S, Am Bor P, KM-Bor, Tim-Bor®(U.S. Borax Inc.), Borogard ZB® (U.S. Borax Inc.) or any Busan® (Buckman Labs. Intl, Inc.) or similar product currently used at tie treatment plants in the manufacture of railroad ties. Further, a borate mixture can be employed such that the borate is mixed or dissolved into a liquid medium (aqueous, polymer-based or otherwise) capable of dissolving or suspending the borate for a period of time.

Dissolution or suspension of the borate in a liquid medium provides many advantages with respect to ease of application in the field. For example, and without limitation, a dissolved form of borate may be easily applied to a laid railroad tie by pouring or spraying. In at least one embodiment, the medium for applying the borate is especially formulated to facilitate the migration of the borate into the untreated wood fibers, yet dries quickly to ensure that the borate cannot inadvertently leach from the tie, as in the case of subsequent perciptiation. The borate mixture can also be formulated to retain the borate within the tie until the conditions are optimal to promote maximum diffusion of the borate throughout the fibers of the wood, such as when the moisture absorption of the tie increases due to local seasonal moisture variations.

The repair composition can be applied directly to a vacated spike hole in a tie. In at least one embodiment, once in the vacated spike hole, the plugging compound undergoes an exothermic reaction as it cures, which functions to kill any existing fungi in or adjacent to the spike hole. Surprisingly, the heat produced from the exothermic reaction is also found to dramatically promote the dispersion or diffusion of the borate beyond the immediate area of the spike hole or other damaged area and into the wood fibers of the body of the tie. In this manner, the borate not only prevents future fungi from entering the wood in the vicinity of the spike hole, but also kills any fungi that has moved into the wood fibers beyond the limited reach of the heat of the exothermic reaction. The chemical plugging compound acts to fill and seal the hole and rot cavity, should a cavity exist, to prevent any future ingress of water and/or microbes into the untreated wood.

Additionally, the repair composition may also be employed to treat damage to the tie such as an adzed, cut, or otherwise stripped portion of the surface of a railroad tie. Treatment of the exposed, untreated wood with the repair composition can thus prevent the invasion of fungi, moisture and/or insects into the untreated portion of the tie. It will be appreciated that the specific formulation of the repair composition may be selected depending on the desired application. For example, in treating an adzed surface of a railroad tie, a repair composition comprising a rapid-curing polymer material (to function as a sealer) and a borate may be selected, whereas a repair composition comprising a polyurethane or polyurea, epoxy or similar plugging compound and a polymer-based borate mixture may be selected for treatment of a spike hole.

In application, the repair composition may be applied to the compromised railroad tie either as a mixture or through the sequential application of its individual components. For application of the repair composition as a mixture, the borate (either alone or in combination with a specifically formulated medium) is first combined with the plugging compound in the desired component ratios. Thereafter, the repair composition is added directly to the compromised portion of the railroad tie. Alternatively, the components of the repair composition may be applied sequentially. In at least one embodiment, the borate of the repair composition is added directly to the compromised portion of the tie, either by a spray or otherwise, prior to the application of the plugging compound. The plugging compound is subsequently applied to repair the physical damage to the tie.

As previously described, once the repair composition is applied to the tie, the exothermic reaction of the plugging compound facilitates the penetration of the borate or borate mixture into the surrounding wood fibers and kills any fungi immediately adjacent thereto. In this manner, after the plugging compound has set, the borate remains locked within the interior of the tie, thus preventing any future insect or fungi attack and the associated decay of the wood. The end result is a restored railroad tie that need not be replaced.

In addition to its use as an anti-fungal and insecticide, borate also has well known fire retardant properties. In yet another embodiment, wooden railroad ties having improved resistance to fire may be prepared by treatment with the borate and polymer systems as described above. As discussed above, the polymer assists in sealing the surface of the wood to retain the borate within the tie and improve resistance to leaching, such as caused by rain or other environmental conditions.

In a preferred embodiment, railroad ties having improved resistance to fire are prepared by treatment with a polymer system comprising an isocyanate and an active hydrogen containing compound. Borate is incorporated into the polymer system by mixing with the isocyanate and/or the active hydrogen containing compound. In a particularly preferred embodiment, the polymer system comprises a 1:1 ratio by volume of isocyanate and water as the active hydrogen containing compound. Borate is mixed with the water in a concentration of about 25% to about 60% by weight and more preferably in a concentration of about 25% to about 40% by weight. The borate mixture is combined with the isocyanate and the resulting polymer system is applied to the tie by spraying, or other suitable means known in the art. As the polymer system cures, it forms a coating on the surface of the tie that acts as a sealant to improve retention of the borate in the tie. The polymer system may also contain one or more additives, as are known in the art. For example, pigments such as iron oxide may be added to provide a visual indication that the railroad tie has been treated.

The composition of the polymer system may vary according to the particular application. For example, relatively thin polymer compositions may be preferable for absorption into the wood and to seal the borate in the wooden tie. Polymer coatings having an average thickness of about ⅛th inch may be used for specialized applications requiring increased resistance to wear and environmental conditions, such as in bridges where the crossties, timbers, stringers, pilings and other components are particularly exposed to weather. The borate may be incorporated into the polymer composition and/or the tie may be treated with a borate and water solution (e.g., by pressure treatment), dried, and then the polymer composition applied to seal the borate in the tie.

In a preferred embodiment, a thick polymer coating is comprised of a 2-component polyurethane having a ratio of polyol resin to isocyanate of about 2:1 by volume. The physical properties of exemplary polyol resin and isocyanate components are shown in the Table 1.

TABLE 1
Polyurethane Material Component Properties

| | Isocyanate | Polyol Resin |
|---|---|---|
| Percent Solid | 100% | 100% |
| Process temperature | 68° F.-85° F. | 68° F.-85° F. |
| Viscosity @ 77° F. (cps) | 175-225 | 750 |
| Viscosity @ 85° F. (cps) | 125-150 | 550-600 |
| Viscosity @ 77° F. (cps) | 250 | 350 |
| Specific Gravity (water = 1) | 1.19 | 1.044 |

| Reaction speed: | |
|---|---|
| Start of reaction | 15-20 seconds (@ 75° F.) |
| Gel time | 20-30 seconds |
| Tack free | 40-50 seconds |
| Cure 95% | 24 hours |

The resulting coating achieves a density of about 68 pounds per cubic foot, and may be applied to the wood surface by spraying, brushing, rolling or other means known in the art. Alternatively, the tie may be immersed in the polymer composition. The coating may be applied either as a single coat or as multiple coats, allowing each coat to set before applying the next coat.

The polymer composition may contain one or more additives as are known in the art. For example, the polymer composition may include an aggregate that imparts a textured non-slip surface to the coating. Additives can be incorporated into the polymer composition or added as the polymer composition is applied. In addition, where multiple coats are used, each coat may have a different formulation. For example, borate may be incorporated into one or more of the coats. Alternatively, the coats may be applied differently. For example, the outer coating may be applied unevenly to form a textured surface.

The resulting coating forms a solid layer that penetrates into the pores and cavities, and mechanically bonds with the wood surface as it sets. The surface of the tie may also be prepared to facilitate adherence of the polymer composition, including by cleaning, sanding or scoring the surface. In one embodiment, the surface of the wood tie is cleaned with acetone or other solvent and allowed to dry before application of the polymer composition.

Polymer coatings may be used with or without borate to provide a substitute for the conventional treatment of railroad ties using creosote, which is a possible carcinogen and generally hazardous material whose disposal is regulated. In addition, creosote typically penetrates only about an ⅛th of an inch into the surface of the wood tie. Handling of the railroad ties during loading, unloading and installation operations frequently causes damage to the surface of the tie that penetrates the thin layer of creosote and exposes untreated wood. In contrast, polymer compositions such as polyurethanes are comparatively non-hazardous and environmentally friendly, and form relatively flexible coatings that can withstand handling and resist cracking or penetration. Further, polymer compositions are relatively easy to apply by spray or brush, which make them particularly suitable for on site repairs in the field. In contrast, creosote is conventionally applied by pressure treatment of railroad ties, which is impractical in the field.

The following examples illustrate the compositions of repair compositions, their preparation, and application as remedial preservatives and the swift and extensive movement of the borate into the wood. The Figures described below serve to demonstrate the improved results described herein. The examples provided are not meant to limit the scope hereof, as is solely defined by the claims.

### EXAMPLE 1

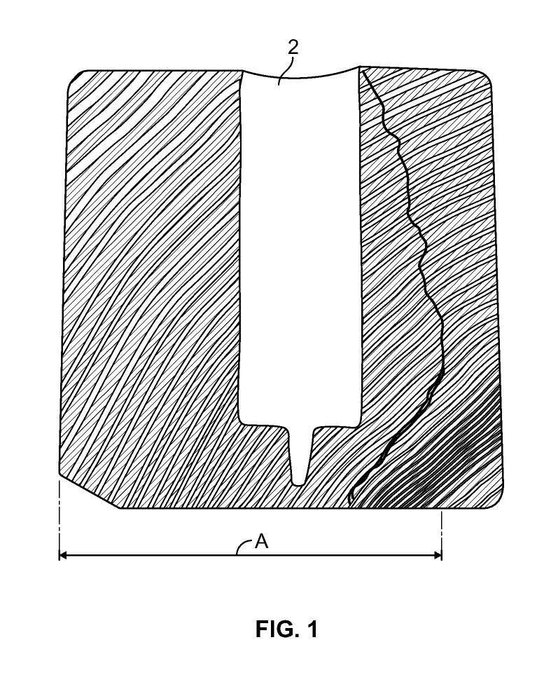

A sprayable borate composition was prepared by blending together: 20% borate (Tim-Bor® from U.S. Borax, Inc.) and 80% water, by weight. This composition was sprayed into a simulated spike hole 2 in a Douglas Fir test specimen and allowed to diffuse. After 24 hours, the test specimen was saw cut through the treated spike hole and analyzed. The extent of diffusion of borate was determined by spray application of a boron indicator using the test procedure described in the American Wood Protection Association book of standards (standard A3-08 section 17). Boron present in an amount of 0.8 kg/m³ or greater will turn the indicator reagent red. As shown in FIG. 1, the borate penetrated a distance A into the wood.

### EXAMPLE 2

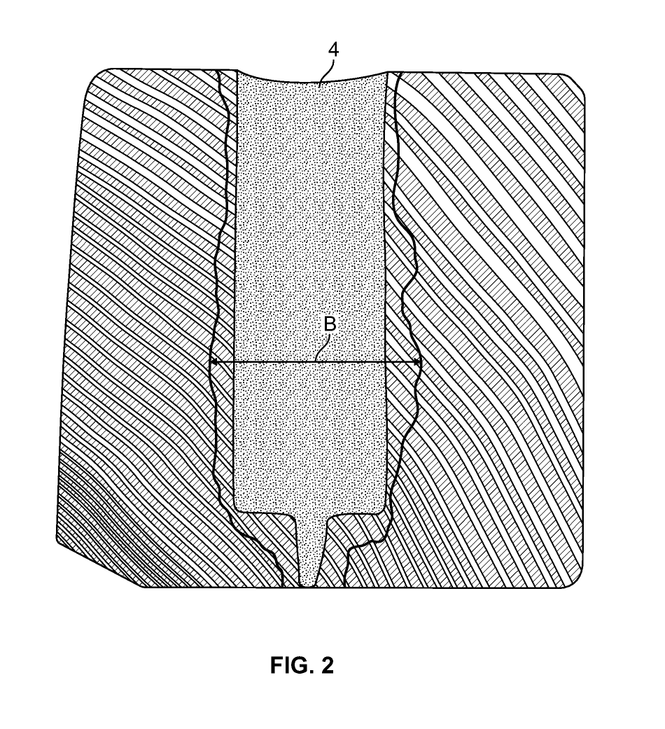

A foam repair composition was prepared by blending together: about 2.5% borate (Tim-Bor® from U.S. Borax, Inc.) and about 2.5% fumed silica (Cab-o-sil® TS-720 from Cabot Corporation) by weight into the polyol component, part “B”, of a standard 2-part foaming polyurethane. The fumed silica was used as a thickening agent to reduce the amount of settling out and keep the borate in suspension in the polyol. The polyurethane compound was then prepared as a 1:1 ratio by volume of isocyanate to polyol. This composition was applied into a simulated spike hole in a Douglas Fir test specimen and allowed to rest and form a plug 4. After 24 hours, the specimen was saw cut through the treated hole and analyzed as described in Example 1. As shown in FIG. 2, the borate penetrated a distance B into the wood.

### EXAMPLE 3

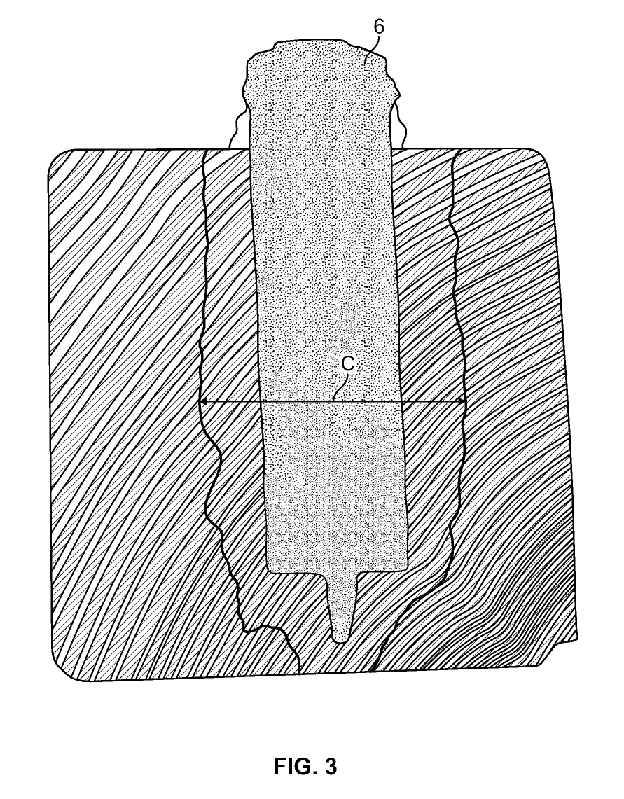

A simulated spike hole in a Douglas Fir test specimen was spray treated with the 20% borate (Tim-Bor® from U.S. Borax, Inc.) solution of Example 1 and allowed to rest for 24 hours. Thereafter, a plugging compound consisting of a Two-Component Spike Hole Filler polyurethane foam (from Encore Rail Systems, Inc.) was applied into the borate treated hole and allowed to cure and form a plug 6. After 24 hours, the specimen was saw cut through the treated hole and analyzed as described in Example 1. As shown in FIG. 3, the borate penetrated a distance C into the wood.

### EXAMPLE 4

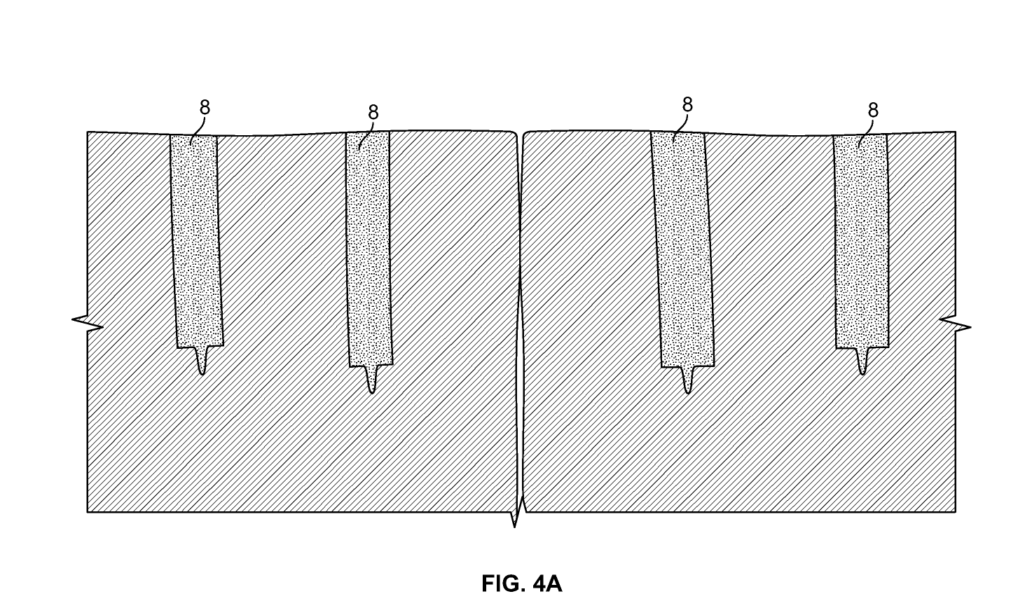

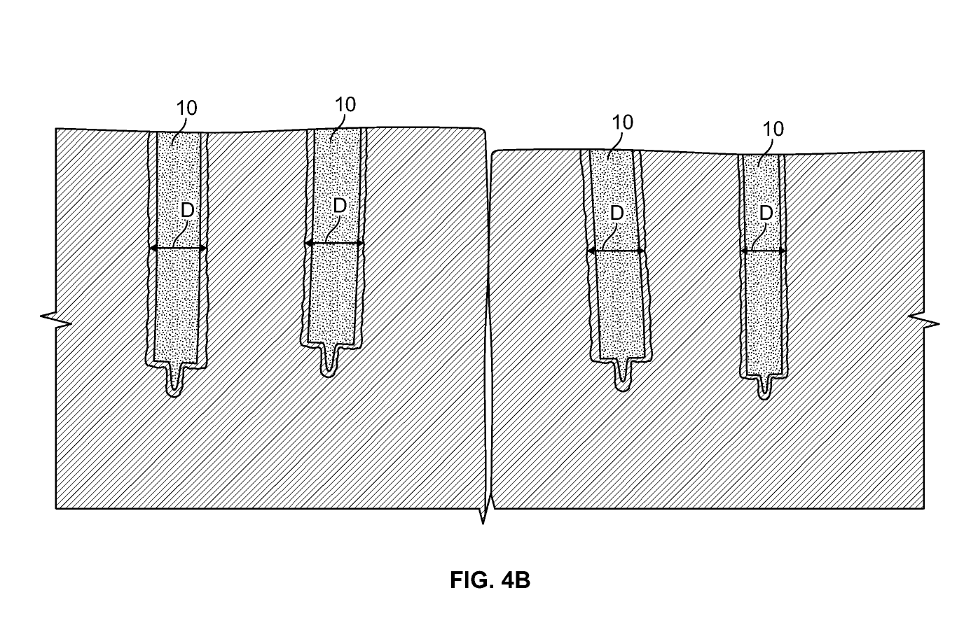

A liquid composition was prepared by blending together: 30% borate (Tim-Bor® from U.S. Borax, Inc.) by weight and an MPX wood coating material containing a black stain obtained from Advantage Coatings (Louisville, Colo.) as a liquid medium. This composition was poured into a spike hole in an otherwise untreated oak tie and allowed to rest. After 24 hours, the 1:1 ratio by volume polyurethane foam composition of Example 2 containing borate was applied to the spike hole and allowed to rest for about 24 hours and form a plug 8, 10. Thereafter, the spike hole was saw cut through the treated hole and analyzed as described in Example 1. FIG. 4a shows the cross section prior to application of the borate indicator but after the applied polyurethane foam composition was allowed to rest, and FIG. 4b illustrates that the borate penetrated a distance D into the wood after the borate indicator was applied per the AWPA test described in example 1.

Those of skill in the art will appreciate that the degree of penetration or diffusion of the borate into the wood may vary according to the species of wood, and the conditions of application. Wood specimens that have larger vessels with fewer obstructions are likely to exhibit greater diffusion of borate. For example, it has been observed that the degree of penetration of borate is greater in sample ties made of red oak in comparison to white oak. It has also been observed that wood specimens that have been pre-soaked with water also exhibit somewhat greater diffusion of borate into the wood.

### EXAMPLE 5

Borate and polymer compositions for treatment of railroad ties to improve fire resistance were prepared as mixture of an isocyanate with a borate solution in a 1:1 ratio by volume. The isocyanate was commercially available methylene diphenyl di-isocyanate (MDI) (9259, Huntsman International). The borate solution was prepared as a mixture of borate (Tim-Bor®) and water in a concentration of either 25% or 40% by weight. The borate was fully dissolved at concentrations as high as about 35% in ambient temperatures. Some undissolved borate was observed at concentrations of about 40%.

Sample railroad ties prepared from commercially available 7×9 inch white oak railroad ties (Koppers, Inc.) cut into 6 inch blocks. New creosote treated and untreated railroad ties were used. For one test, an old creosote treated railroad tie was used that had been in service for about 20-25 years. The borate and polymer compositions were applied to the surface of the sample blocks by dip coating, and then allowed to air dry for a period of about 24 hours.

### EXAMPLE 6

The fire retardant properties of the borate and polymer compositions were tested by heating a 1.5 inch steel cube with a torch until red hot (a temperature of well over 600° F.) and then placing the heated steel cube on sample blocks prepared as described in Example 5. The heated steel cubes caused the sample blocks to burn and resulted in a flame whose duration was timed. After a period of 10 minutes, the heated steel cubes were removed and the burn depth was measured with a depth micrometer. The results of the test are shown in Table 2.

TABLE 2
Fire Retardant Tests

| Test | Sample Block | Composition | Flame Duration | Burn Depth (mm) |
|---|---|---|---|---|
| 1 | untreated | none | 3 min. | 2.489 |
| 2 | untreated | 25% borate | 2 min. | 1.854 |
| 3 | untreated | 40% borate | 2 min. | 2.057 |
| 4 | creosote | none | 4 min. | 2.641 |
| 5 | creosote | 25% borate | 5 min. | 2.362 |
| 6 | creosote (old) | 25% borate | 4 min. | 2.590 |
| 7 | creosote | 40% borate | 3 min. | 1.828 |

Railroad ties treated the borate and polymer compositions exhibited improved fire resistance in comparison to untreated and creosote treated railroad ties. The borate and polymer composition significantly reduced the flame duration to only about 2 minutes, which was a reduction by about ⅓ the time for untreated railroad ties and about ½ the time for creosote treated ties. The burn depth was also significantly reduced to about 2 mm or less, which was a reduction of about 20% or more in comparison to untreated and creosote treated railroad ties. The borate and polymer composition had reduced effect when used on creosote treated railroad ties, likely due to the inability of the composition to penetrate into the creosote treated tie. Once the heated cube burned through the region of the railroad tie protected by the borate and polymer composition, the flame continued to burn due to the creosote. Significant reduction in flame duration and burn depth for creosote treated railroad ties required compositions with higher concentrations of borate (e.g., Test 7). It is believed that thicker coatings of borate and polymer compositions as described above can also compensate for the lack of penetration in creosote treated railroad ties and provide improved resistance to fire.

While various embodiments of a repair composition, and methods for producing and using the same have been described in considerable detail herein, the embodiments are merely offered by way of non-limiting examples of the disclosure described herein. Many variations and modifications of the embodiments described herein will be apparent to one of ordinary skill in the art in light of this disclosure. It will therefore be understood by those skilled in the art that various changes and modifications may be made, and equivalents may be substituted for elements thereof, without departing from the scope of the disclosure. For example, it will be understood that any type of plugging compound or plugging media, such as wood dowels, may be employed in the repair composition disclosed herein. Furthermore, the compositions described herein are not limited to the repair or other remedial treatment of railroad ties, but may be used in the fabrication of new ties. Indeed, this disclosure is not intended to be exhaustive or to limit the scope of the disclosure. The scope of the disclosure is to be defined by the appended claims, and by their equivalents.

It is therefore intended that the disclosure will include, and this description and the appended claims will encompass, all modifications and changes apparent to those of ordinary skill in the art based on this disclosure.

What is claimed is:

1. A polymer system for treatment of railroad ties to improve resistance to fire, comprising:
an isocyanate;
an active hydrogen containing compound; and
a borate compound in an amount of about 25% to about 60% by weight of the active hydrogen containing compound.

2. The composition of claim 1, wherein the borate compound is in an amount of about 25% to about 40% by weight of the active hydrogen containing compound.

3. The composition of claim 1, wherein the isocyanate and active hydrogen containing compound are in a ratio of about 1:1 by volume.

4. The composition of claim 1, wherein the active hydrogen containing compound is water.

5. The composition of claim 1, wherein the active hydrogen containing compound is a polyol.

6. The composition of claim 1, further comprising a pigment.

7. A railroad tie having improved resistance to fire, comprising:
a railroad tie; and
a coating applied to the railroad tie comprising:
an isocyanate;
an active hydrogen containing compound; and
a borate compound in an amount of about 25% to about 60% by weight of the active hydrogen containing compound.

8. The railroad tie of claim 7, wherein the borate compound is in an amount of about 25% to about 40% by weight of the active hydrogen containing compound.

9. The method of claim 8, wherein the isocyanate and active hydrogen containing compound are in a ratio of about 1:1 by volume.

10. The railroad tie of claim 9, wherein the active hydrogen containing compound is water.

11. The railroad tie of claim 9, wherein the active hydrogen containing compound is a polyol.

12. A method for treating railroad ties for improved resistance to fire, comprising:
providing a railroad tie;
providing an isocyanate and an active hydrogen containing compound;
mixing the active hydrogen containing compound with a borate compound in an amount of about 25% to about 60% by weight of the active hydrogen containing compound;
combining the isocyanate and the borate mixture; and
applying the combined isocyanate and borate mixture to the railroad tie.

13. The method of claim 12, wherein the isocyanate and the active hydrogen containing compound are provided in a ratio of about 1:1 by volume.

14. The method of claim 12, wherein the borate compound is in an amount of about 25% to about 40% by weight of the active hydrogen containing compound.

15. The method of claim 12, wherein the active hydrogen containing compound is water.

16. The method of claim 12, wherein the active hydrogen containing compound is a polyol.

17. The method of claim 12, wherein the combined isocyanate and borate compound is applied to the railroad tie by spraying.
